(19) United States
(12) Patent Application Publication
(10) Pub. No.: US 2001/0044813 A1
(43) Pub. Date: Nov. 22, 2001

(54) Document production platform

(76) Inventor: Kenneth B. Frank, Baltimore, MD (US)

Correspondence Address: DENIS G. MALONEY, Fish & Richardson P.C., 225 Franklin Street, Boston, MA, 02110-2804, US

(21) Appl. No.: 09/758,035

(22) Filed: Jan. 10, 2001

Related U.S. Application Data
(60) Provisional application No. 60/175,182, filed on Jan. 10, 2000.

(51) Int. Cl. G06F 17/24

(52) U.S. Cl. 707/530; 707/532

(57) ABSTRACT

A document production platform is provided which is an open, modular, scalable software platform for developing and deploying knowledge-based software products. The document production platform supports integration with a wide range of databases and word processors. Because of its modular design, the document production platform components can be integrated into other products. Because the document production platform's underlying functionality operates independently of the user interface, new methods of delivering the document production platform dynamic content are possible with limited programming effort.

This application claims priority from Provisional Application No. 60/175,182 filed Jan. 10, 2000, the contents of which are incorporated herein by reference in their entirety.

### TECHNICAL FIELD

This invention relates to document assembly and expert systems, and more particularly to an expert system for creating complex dynamic documents using rules.

### BACKGROUND

Simple document assembly programs which link fields in a document to fields in one or more databases are known. Such programs perform a simple, direct substitution. With some additional programming effort, they may engage in dialogue with a user to obtain needed information so as to select alternative choices based upon user input. However, such programs are essentially static, dumb substitution systems.

### SUMMARY

The document production platform is an open, modular, scalable software platform for developing and deploying knowledge-based software products. Designed as a modular set of components, products are defined in the document production platform without regard to the ultimate delivery mechanism. Thus, the same application can be delivered via shrink-wrapped Windows® desktop products, client-server Intra/Internet offerings, or a combination thereof.

The document production platform supports integration with a wide range of industry-standard databases and word processors. Further, because of its modular design, the document production platform components can be integrated into other products. Finally, because the document production platform's underlying functionality operates independently of the user interface, new methods of delivering the document production platform dynamic content are possible with limited programming effort.

According to one aspect of the invention, a document production platform is provided. The document production platform uses a computer implemented process to automatically draft complex documents, analyses, forms, letters and other textual material and provides material for complex documents based on interaction among information provided by a user. The document production platform can retrieve information stored in relational databases based on expert rules provided by one or more authors, and text fragments organized into one or more templates.

In another aspect, a user is able to manipulate the contents of the complex documents by changing information. In yet another aspect, the document production platform has a rule-based processing engine which supports interactive question and answer sessions with a user to gather data, inform the user and present the results of an analysis.

In still another aspect, data elicited during the process is available for drafting a document. In another aspect, the process may access data from industry standard database engines and display and/or update that information, and stores are defined in a dictionary and may be joined to information from multiple sources can be presented to a user or used in a knowledge application.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of data flow in a document production platform.

FIG. 2 is a hierarchical diagram of functional components of a document production platform.

FIG. 3A is a structural diagram of the client side of a client-server embodiment of the document production platform.

FIG. 3B a structural diagram of the server side of a client-server embodiment of the document production platform.

FIG. 4 is a screen shot of a dictionary handling process.

FIG. 5 is a table showing image properties of buttons.

FIG. 6 is a data flow diagram.

FIG. 7 is a screen shot of a sample document in process using a document production platform.

Like reference symbols in the various drawings indicate like elements.

### DETAILED DESCRIPTION

Described below is a document production platform provided for the development of products covering a wide spectrum of complexity, from simple forms to complex integrated practice systems.

The document production platform's capabilities arise out of its ability to apply rules to information, whether provided by a user during an interactive Question and Answer session or obtained from a database, and assemble the information based on the rules into appropriate text that can be used to generate the complex documents. The knowledge of the document production platform application includes rules, text and reference data developed by content experts, enabling the document production platform to interpret the information on demand to suit a user's needs. By way of a non-limiting example, in a legal application, rules are used to determine how applicable laws and regulations in a particular practice area are applied to the user's specific facts and circumstances.

The document production platform is made up of an integrated suite of tools for the creation, management and manipulation of data and text. The document production platform treats both data and text as objects, somewhat similar to the concept of objects in an object oriented programming language. The objects in the document production platform consist enable users to combine data from a variety of sources with text and rules, and assemble them into applications with decision processing, data management, interactive on-line explanations and dynamic text assembly capabilities. The development tools produce a variety of dynamic objects, which can be accessed individually or as part of an integrated application. Such objects include text (which may contain rules and definitions for user interaction, data objects, rule objects and explanatory material with rules which allow different portions to be displayed depending upon changing circumstances.

The document production platform’ primary capabilities include the following:

Interactive Document Preparation—The document production platform can automatically draft complex documents, analyses, forms, letters and other textual material based on the interaction among information provided by a user, information stored in relational databases, expert rules provided by one or more authors, and text fragments organized into one or more templates. The documents prepared by the document production platform can be dynamic, allowing a user to manipulate the contents merely by changing one or more pieces of information.

Decision Processing—The document production platform incorporates a rule-based decision processing engine, supporting interactive Question and Answer sessions with a user. These Q&A's gather data, inform the user, and can if desired present the results of an analysis as a part of the Q&A. The data elicited during this process is then available for drafting of one or more documents.

Data Management—The document production platform can utilize data from a range of industry-standard database engines and display and/or update that information. Data stores are defined in the document production platform dictionary, and can be joined so that information from multiple sources can be presented to a user or used in a the document production platform knowledge application. Described below is a document production platform provided for the development of products covering a wide spectrum of complexity, from simple forms to complex integrated practice systems.

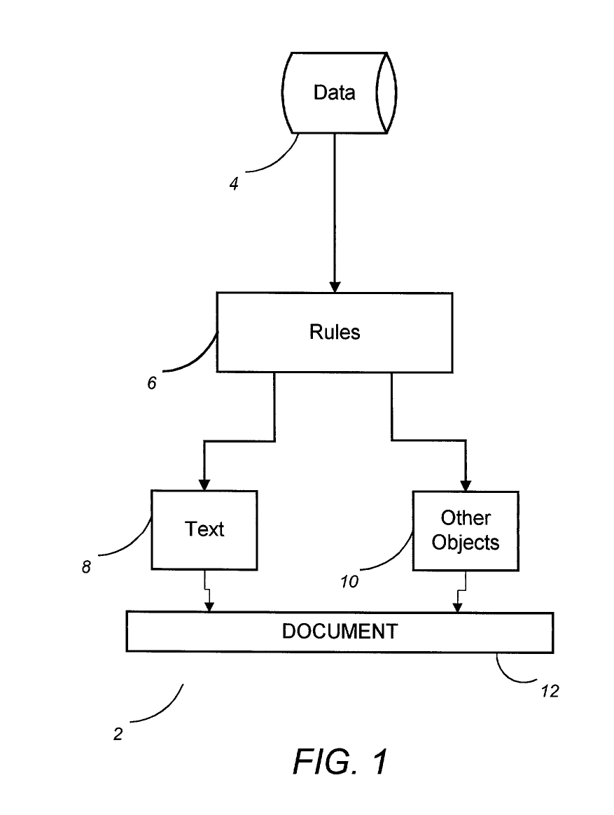

Referring to FIG. 1 data flow 2 in the document production platform is shown. Data 4 in the form of input from a user in manners described above is operated on by rules 6 to yield text 8 and other objects 10 which are then applied to a document 12. The text 8 and other objects 10 are stored in a computer system separately.

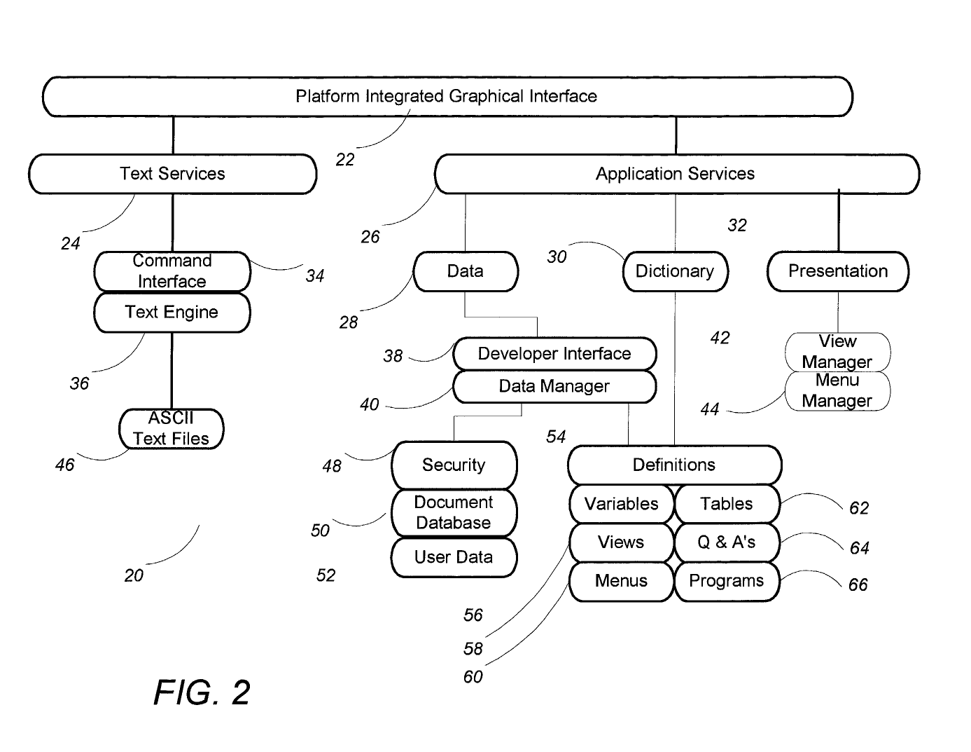

Referring to FIG. 2, the document production platform can be deployed as either an integrated Windows desktop product, or a client-server, component object architecture appropriate for either network (including but not limited to the Internet) or distributed desktop environments. The development components of the document production platform use the desktop implementation.

The document production platform desktop is a modular set of dynamic link libraries that perform the various functions in the document production platform application. The hierarchy of the functional components 20 includes text services 24 and application services 26 that are integrated at the user level with a platform integrated graphical interface 22. Contained within an Multiple Document Interface (MDI), are two primary divisions of functionality: Text Services 24, assembles, composes, displays and prints all text, whereas the Application Services 26, interacts with user data 28, dictionary 30 information, and so forth to present and process the underlying application.

Application services includes services to handle data 28, the dictionary 30 and presentation 32. The services to handle data include developer interface 38 and a data manager 40. The data manager handles security 48 features for the application services, handles the document database 50, and user data 52. The dictionary 30 services provided by application services handle definitions 54, variables 56, views 58, the user menus 60, tables 62, Q&A 64, as well as programs 66 that are managed by the application services 26. The presentation 32 aspect of the application services includes a view manager 42 and a menu manager 44. The data manager 40, view manager 42, and menu manager 44 modules are discussed in detail below. The modules comprising the Application Services 26 rely on definitions stored in the document production platform Dictionary 30, e.g., a series of database files managed by the Dictionary 30. Each of these runtime modules is designed to operate independently of the others.

The Dictionary includes definitions 54 for variables 56, views 58, menus 60, tables 62, question and answer sequences 64 and programs 66.

By way of a non-limiting example, when one function requires a data value, the name of the variable is passed to the Data Manager 38, which uses the definitions in the Dictionary 30 to enable it to obtain that value and return it to the calling process. Similarly, when a process requires a dialog box or Wizard (a user friendly programmed sequence to interact with a user to obtain information or to perform a function requiring input from a user), the process passes the process ID to the View Manager 40, which produces the needed dialog box or sequence of screens.

In one embodiment, the interface is built to a Windows standard. Other embodiments using different operating systems may also be employed. Tabbed dialog boxes, right mouse menus, multiple tool and button bars, etc. are built in as standard functions.

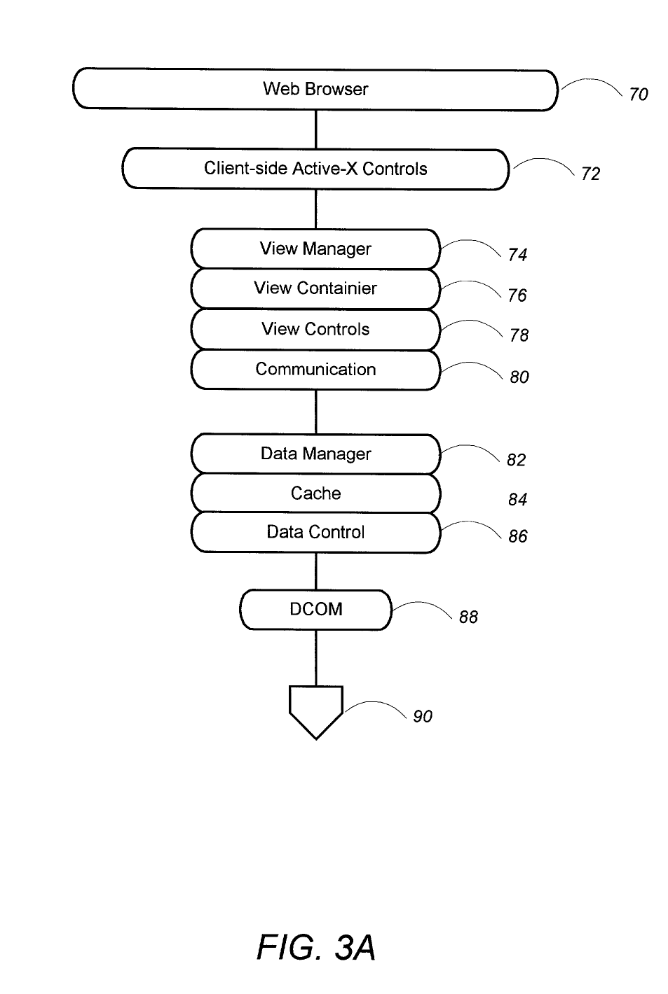

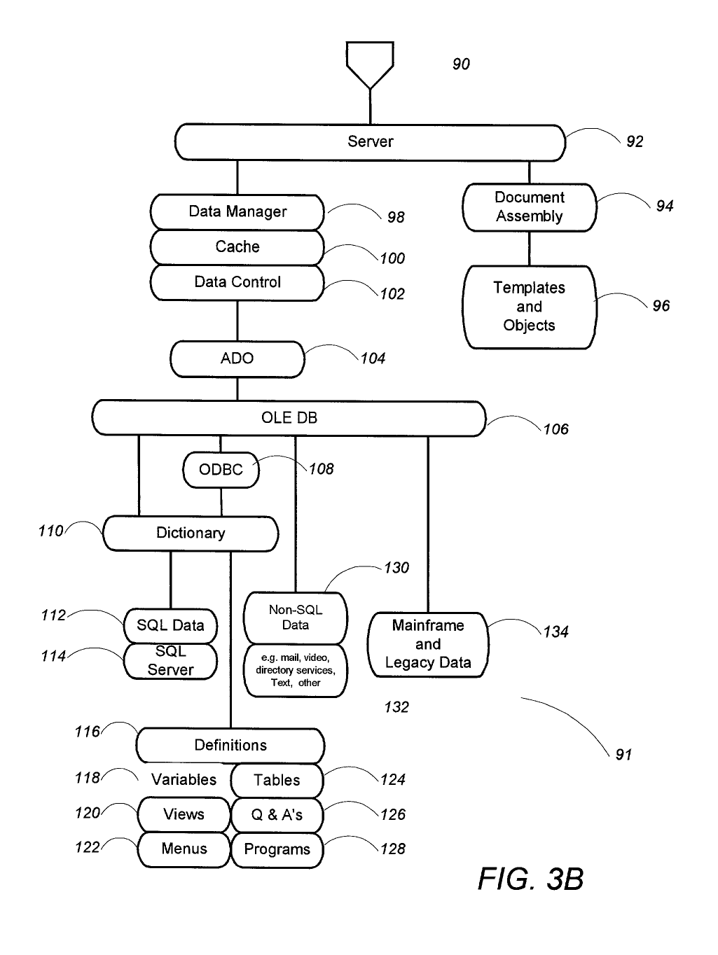

Referring to FIG. 3A, a hierarchical map of a client process 60 that can be part of the document production platform is shown. A Client-Server embodiment of the document production platform is a component object design, in which a relatively small client controls communicate with server processes, to process the application. Because of the underlying design philosophy of the document production platform in which the processes and functions are independent of the interface, this embodiment is capable of operations in either a desktop graphical user interface (GUI) or a Web Browser. The Web Browser 70 interfaces to client-side Active-X controls 72, whereas the GUI interface would have event driven controls.

The Client-Server version of the document production platform can be deployed in at least two alternative interfaces: desktop and Web browser. The desktop implementation is virtually identical to the Integrated Desktop version of the document production platform.

The View Manager 74 provides the view container 76 (described below), view controls 78 and communication facility 80. The Data Manager 82 provides cache 84 and data control in the form of distributed communications (DCOM) communicators.

Referring now to FIG. 3B, a server process for the client-server embodiment of the document production platform is shown. The client side communicates over a connection 90 with the server side 91. This connection may be a local area network, the Internet or other form of network connection. The server process 92 includes the data manager 98, cache 100, and data control 102. The data manager process 98 feeds an ADO 104, which feeds OLE DB object 106. The OLE DB can retrieve information from various databases such as the dictionary 110 either directly or through an ODBC interface 108, as well as SQL data from an SQL Server 114, non-SQL data 130, such as E-Mail, video, directory services, text, and other similar information, and can also retrieve information for mainframe and legacy data 134. The dictionary includes definitions 116 variables 118, views 120, menus 122, tables 124, O & A's 126 and programs 120. The server process 92 includes the document assembly module 94, which retrieves templates and objects from the template an object database 96. Thus, the OLE DB object is responsible for Data Management. The document production platform uses data from a range of industry-standard database engines and displays and/or updates that information. Data stores are defined in the document production platform dictionary, and can be joined so information from multiple sources can be presented to a user or used in the document production platform knowledge application.

The data manager and the document assembly process enable the document production platform to automatically draft complex documents, analyses, forms, letters and other textual material based on the interaction among information provided by a user, information stored in relational databases, expert rules provided by one or more authors, and text fragments organized into one or more templates. The documents prepared by the document production platform can be dynamic, allowing a user to manipulate the contents merely by changing one or more pieces of information.

The document production platform uses the expert rule-based, decision-processing engine to support interactive Question and Answer (Q&A) sessions with a user. These Q&A sessions are used to gather data, inform the user, and can if desired present the results of an analysis as a part of the Q&A. The data elicited during this process is then available for drafting of one or more documents.

The document production platform development environment includes two modules, each of which is used to design a number of the components available at runtime.

The Dictionary 30 is where all aspects of the data and interface portions of the document production platform applications are created or defined. The data objects are files, fields (or “variables”), keys and joins. The interface objects are views, sequences (“Wizards”), menus and programs.

The primary data elements, or “variables”, used in any portion of the system are defined in the Dictionary 110. They may exist or be created as fields in existing industry standard database files such as SQL data 112 provided by an SQL server 114, or they may be defined in the Dictionary as “unassigned” variables 118, managed by the document production platform. The user or developer may assign intelligible English language names to all variables 118 in addition to the cryptic name they may have in their native database.

Additional variables 118 may also be defined as calculations based on other variables. These may be date, arithmetic or string calculations, enabling a change in one value in a database to trigger a series of other values.

To the extent variables 118 are stored in external database files, keys and joins may be defined, providing access to specific records and enabling data from diverse sources to be linked together into one logical database. In this way, users of the document production platform application may access data from a variety of sources, such as non-SQL data 130, within a single process without knowing the source of the information. Examples 132 include, but are not limited to E-mail, video, directory services, text and other sources. within a single process without knowing the source of the information.

Using variables 118 as building blocks, the interface objects may be defined. The primary interface object is called a “view”. A view is a presentation or collection of a group of variables. Views may be dialog boxes or tables intended for user interaction, or they may be created for other internal purposes such as import/export or control of other processes. They can be used as steps in interactive “Wizard-like” Q&A sessions, they can be called from menus, or they can be embedded in text objects providing direct access to data from within text output.

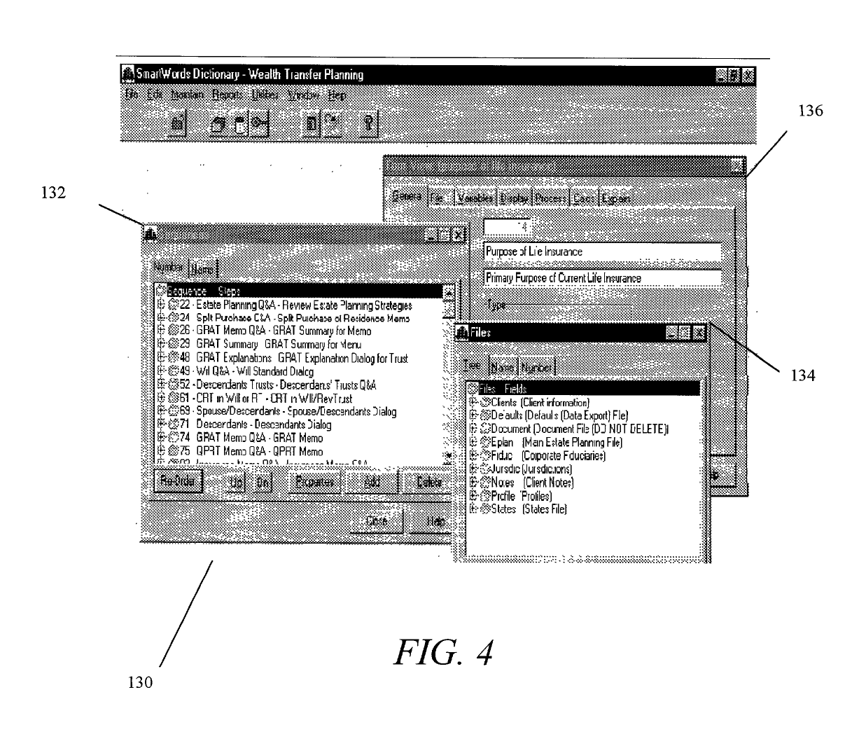

FIG. 4 shows a screen shot of dictionary management development tool 130 implemented in a Windows® environment. It has separate windows for each of sequence management 132, files management 134 and views management 136 functions.

Text objects are defined in the Library. A text object can be of any size, and can contain a number of other components, including conditional text, graphics, data objects, explanations, and embedded messages. Text may be created in the Library or imported from any industry-standard word processor, web page editor, or obtained on-line or from any other text source. Once constructed, text objects can be accessed directly or dragged into templates used to create documents for particular transactions.

The Library includes tools to organize text objects into multiple user-defined hierarchical outline structures along with additional tools necessary to create, edit and test text objects. Conditional text is easily created using a graphical expression editor providing access to available data objects, operators and previously saved expressions. Conditional text may be nested within conditional text, and graphical color displays of the text enable a developer or advanced user to see the logical relationships within the text.

Table 1 shows a tree detailing the exposure and dependencies of the various the document production platform components.

TABLE 1
SWVMCont.OCX --View Manager Container

SWVMForm.OCX --View Manager Form Module

SWVM.OCX --View Manager

SWVMMask.OCX --Masked character Input
SWVMReal.OCX --Real number editing
SWVMDate.OCX --Date editing
SWVMTime.OCX --Time editing
SWTab --Graphical Tabstrip control
SWTable --Database Table view control --under

construction
SWButton --Back/Next Graphical buttons
SWLabel --Smart Label control
SWTree --Navigable Tree control

The four top level controls—SWVMCont. SWButton, SWLabel & SWTree—are the controls used directly by an interface application.

In general, it is preferable to build the intelligence of the system into the Application. The Development tools (Dictionary. et. al) are the primary methods for creating and maintaining functionality within a Q&A process or document. The modules described do not require very much effort on the part of an “interface developer” (also referred to here as a “container programmer”). Only a minimum amount of container programming is required.

SWVM—The ViewManager.

Although not at the top of the hierarchy, SWVM. OCX (ViewManager) controls the client-side flow of a the document production platform Q&A. It resides a few layers down in the control hierarchy, but its immediate containers generally obey its directions and reflect properties and events up and down respectively.

Functionally, ViewManager contacts the DataManager (SWDM_D. DLL) to receive meta-data about a Q&A, and then interprets this meta-data into a “screen” by asking its container, TheForm (SWVMForm. OCX), to create a control to represent each variable. The API between ViewManager and The Form is completely hidden from the user of the top level components. It is preferred that the view manager only be used within SWVMForm.

SWVMForm—The View Manager Form

As discussed above, SWVMForm (TheForm) manages the various controls used to represent data on a Q&A screen.

When ViewManager determines that it needs to display a control (e.g. a real number), it triggers an event up to TheForm to do so. TheForm manages a pool of controls for ViewManager, creating them and interpreting ViewManager's request into whatever properties are appropriate for a particular control. TheForm isolates the ViewManager from the actual control implementation. It is a simple process to replace control handlers for certain data types without modifying the ViewManager. When values are changed in a control, TheForm notifies ViewManager of the change, which can then be returned to the DataManager.

TheForm also acts as an intermediary between the ViewManager and the ViewContainer (SWVMCont). Since the ViewContainer is the TopLevel control, most of it's properties are passed directly through to TheForm, which in turn passes them through to ViewManager. Likewise, certain events of the ViewManager need to be passed to the outside container, and are therefore channeled up through TheForm.

As with ViewManager, the events and properties of TheForm are not necessarily relevant for working with the system. Also, as with the ViewManager, it is preferable to use TheForm only on a ViewContainer control.

SWVMCont—The view Container.

The SWVMCont control (ViewContainer)is the top level control used to implement a Q&A session. This is the control container applications will include, and therefore its properties, methods and events are shown in below in Table 2.

TABLE 2

| PROPERTY | TYPE | COMMENTS |
|---|---|---|
| Action | Integer | Functions as a pseudo-method. Generally, you set one or |
| | | more other properties and then set an Action code. The |
| | | following Action values are of use to Container |
| | | programmers: |
| | | ActionStartProcess = 0 --start a document production |
| | | platform Process (c. f. DMSettings) |
| | | ActionNext = 1 --Move to the next step of a Q&A |
| | | ActionPrev = 2 --Move to the Previous Step |
| | | ActionCancel = --Cancel &fire the UnloadVM event |
| | | ActionInfoBox = 23 --called via Ctrl-I to popup a message |
| | | box with info about the current Screen. |
| BackColor | OLE_COLOR | Screen background color. Generally copied though as the |
| | | background color of all controls on the Q&A screen, |
| | | although some do not support backcolor options. |
| DMSettings | String | This is a generic set of “Param1 = Value1\|Param2 = Value2\|. . .” |
| | | parameter/value pairs. It must be set BEFORE setting |
| | | Action = 0 (ActionStartProcess). It represents parameters of |
| | | the DataManager. The actual connection to the Host |
| | | computer running the DataManager Server components will |
| | | be attempted upon receiving this property. After setting this |
| | | property, check the DMInterface property --0 indicates |
| | | Failure/non-Zero indicates success. If connection fails, this |
| | | property may be resent to attempt connection again. If |
| | | connection succeeds, this property can be used again, but |
| | | connection parameters will be ignored (i.e. other |
| | | DataManager parameters may be sent without |
| | | reconnecting.) |
| | | The following named parameters are required for a the |
| | | document production platform application to connect: |
| | | ServerURL = HostComputerName. This should be the |
| | | name of a machine running SWDM_S.EXE |
| | | (DatamanServer). The name can be a URL (IP address- |
| | | 38.165.194.3 or UNC -TTG. COM [WHAT? NEED |
| | | EXPLANATION OF THIS. WHY A SPECIFIC IP |
| | | ADDRESS SHOWN?), or it may be left blank to run off the |
| | | current computer, (Left blank means “ServerURL= 1”--this |
| | | parameter should not be left out.) |
| | | ApplicationName = AppShortName. For example, Wealth |
| | | Transfer Planning's short name is “EPLAN” |
| | | Transaction Number= # This can relate to any existing |
| | | database, such as client and matter number. |
| | | Document Number= # A sequential number assigned to a |
| | | document within each transaction number. |
| | | The following parameters are required for certain |
| | | operations. |
| | | ServerMapPath = Drive, Path &File spec. Required only if |
| | | Creating an output document. Connection and Q&A |
| | | processing will proceed without this parameter, but |
| | | document creation will fail. Basically, the Document |
| | | Assembly routine needs to know where to physically write |
| | | an output file, and the ViewManager needs to know where |
| | | to pick it up from. In the world of Browsers, this value can |
| | | be written into an HTML page by the Server before being |
| | | presented to the browser. The setting should include a file |
| | | name, which is stripped off and replaced by a subdirectory |
| | | name of “SWDocs” E. g.: |
| | | ServerMapPath = C:\WEBSHARE\WWWROOnTTG\vm2dm.asp |
| | | will cause documents to be created in: |
| | | C:\WEBSHARE\WWWROOT\TTG\SWDocs |
| | | AppLongName = Full name of Application, e. g. “Wealth |
| | | Transfer Planning”. Used for message box error conditions. |
| | | All processing will function without this parameter. |
| | | The following parameters are required ONLY if |
| | | DocumentNumber = 0 (See Document Number above) |
| | | Document Type = DocType. This must be one of several |
| | | document types as defined by the application itself. It is |
| | | typically a string of less than 10 chars. |
| | | Document Description = This is a longer description of the |
| | | document. |
| | | Document View = # This is the Application ViewNumber |
| | | associated with this DocType. The DocumentView defines |
| | | the set of data values that this document can access. |
| | | Document Template = the identification of document |
| | | template to be used. |
| | | Document Q&A = # This is the number of the Q&A to run |
| | | for a particular document. |

Once a Document has been created, this information is stored in the system. Therefore, when specifying a document number, a user need not specify the View or Q&A, since it has been recorded with the Document.

SWVMCont Methods:

ButtonAction(ButtonEvent as Integer, ButtonID as Integer)

Inform ViewManager of an event on a “Button”.

ButtonEvents are:

GotFocus=19

Click=19

ButtonIDs are:

Back=5

Next=6

Cancel=7

Help=26

A user does not have to use the SWButton Control to call this method. The SWButton Control has no knowledge of the ButtonIDs used by the ViewManager. The Container code is responsible for calling this Method.

It is preferable to handle focus changes outside of the View Screen. When focus leaves a ViewManager Control, its value is writtenback to the DataManager. In alternative UserInterfaces. it is preferred that “ButtonAction(GotFocus, Next)” be called anytime focus leaves the ViewManager.

To Step Forward in the Q&A process. call:

ButtonAction(Click, Next)

To Step Backward in the Q&A process. call:

ButtonAction(Click, Back)I

To change the mouse cursor to a ?/Arrow which will let you click on a variable name or value to get help, call:

ButtonAction(Click, Help)

To Cancel the Q&A process. call: -_{—}

ButtonAction(Click, Cancel)

TreeSelect(KeyString as String)

Tell the ViewManager to switch to a particular element of the Navigation tree. When items are added to the Navigation Tree (see SequenceTree event below), each item is identified by a unique KeyString. This string is used here to switch to a particular step of the Q&A process.

SWVMCont Events:

The following set of Events are raised by the ViewContainer and may be dealt with by the Container application.

ButtonSetting(ButtonID As Integer, PropertyName As String, Setting As Integer)

Raised to set properties of the interface buttons. Used, for example. to disable “Back” button on the first step of a sequence. For ButtonID values. see ButtonAction method above. Valid Property Names are “ButtonType”. “Visible”, and “Enabled”. See SWButton (page 22)control for info on ButtonType property.

MoveFocus (By Val Which Button As Integer)

Moves focus to a control off the ViewScreen. There are situations (e.g. an Explanation View)when there are no focusable controls on the ViewScreen. In those situations. we attempt to set focus to one of our buttons (typically “Next”). This Event lets the container determine what to do with that request.

NewProcess (DrivingView As Integer, ProcessNumber As Integer, ProcessType As Integer, ViewMode As Integer, LookupString As String)

This Event is raised to inform the Container that it may need to take action.

Most of the information is passed directly from the SW Application.

The following Parameter combinations are predefined:

ProcessType=‘P’/ProcessNumbex=0

This is used to indicate that a file has been generated. The Filename is in the LookupString Parameter. For example. the HTML container for the document production platform Q&As handles this event by saying:

If (ProcessType=And ProcessNumber=0) Then ‘P=ASCII 80 top. location=LookupString

SequenceState(ByVal State As String)

This Event is raised to let the container preserve a “State” indicator, tracking where the user is in the Q&A. This state string is read and moved to the appropriate position in the Navigation Tree. An Action code may be implemented optionally to bypass ActionStartProcess when joining a Q&A already in progress.

SequenceTree(ByVal Action As Integer, ByVal Parent As String, ByVal Child As String, ByVal Text As String)

This event is raised to add/modify elements in the SWTree navigation control.

SetExtPrompt(Text As String)

This event is raised to change the Extended Prompt for the Variable that has focus. The container may show this text anywhere it likes. The Browser version of the document production platform uses an SWLabel control to show this text.

UnloadVM( )

This event is triggered when the document production platform believes it has finished processing a Q&A. It may also be triggered for certain critical errors or when the control is being shut down. In any case. the container must decide what to do upon receiving it. In a web browser embodiment, this may be handled by saying

“top. location=history. back”.

In a stand alone application, it may terminate.

SWTree—The Navigation Tree

The Navigation Tree (known internally as the SequenceTree) is completely independent of the document production platform application, and may in fact be used for almost any type of Tree control display. All properties that correspond to display units are in TWIPs [1/20 of a POINT, i.e. 1440=1 inch] unless otherwise noted.) It is desirable to support at least the properties/methods/events shown in Table 3 below:

TABLE 3

| Property | Type | Comments |
|---|---|---|
| BackColor | OLE_COLOR | Background color |
| ForeColor | OLE_Color | Color of text in tree branches |
| Fontxxxx | Various | Standard font properties for the Text is |
| | | supported, including |
| | | FontName\|FontSize\|Font Bbidletc . . . Default = MS |
| | | Sans Serif 10Pt |
| Indent | Integer | Amount to indent horizontally at each level of the tree. |
| | | Default value = 300 (@ 0.2 inches) |
| FirstIndent | Integer | Amount to indent horizontally before the |
| | | FIRST level of the tree. Default value = 300 (@ 0.2 |
| | | inches) |
| PlusMinusIndent | Integer | Amount to add to Indent property if |
| | | UsePlusMinus = True. Default value = 240 (@ 1/6 inch) |
| LineSpace | Integer | Vertical space between each line. |
| | | Default value = 300 (@ 0.2 inches) |
| FirstLineSpace | Integer | Vertical space before FIRST line. |
| | | Default value = 150 (@ 0.1 inches) |
| UsePlusMinus | Boolean | Should items which contain Sub-items have a |
| | | plus/minus indicator in front of them. |
| | | Default = False |
| ChildNode | String | Unique Key Value used to reference a |
| | | particular item in the tree. Can be any unique string. |
| | | This string does not display, but is used internally. |
| ParentNode | String | When creating a new item, this property |
| | | indicates the item UNDER which the new item should |
| | | be placed. If Empty, the node is created at the top |
| | | level. |
| NodeText | String | This is the Text that actually displays for a given Item. |
| Action | Integer | Functions as a pseudo-method. Generally, a user sets |
| | | one or more other properties and then sets an Action |
| | | code. The following Action values are of use to |
| | | Container programmers: |
| | | AddNode = 0 --Takes ChildNode, ParentNode, and |
| | | NodeText and adds an item to the tree. |
| | | RemoveNode = 2 --Takes a ChildNode and removes it |
| | | (and it's children)from the tree. |
| | | RemoveChildren 1 , --Removes the Children of |
| | | ChildNode, without removing ChildNode. |
| | | RemoveAllNodes = 4 --Empties the entire tree. |
| | | ExpandNode = 5 --Shows all IMMEDIATE children of |
| | | ChildNode. (Does not necessarily show all |
| | | descendants.) |
| | | CollapseNode = 6 --Hide all immediate children of |
| | | ChildNode |
| | | SelectNode 7 --Make ChildNode the currently |
| | | selected node (i. e. mark it with a red arrow) |
| | | DrawTree = 8 --Force Drawing of the tree. The tree is |
| | | NOT repainted during most of the other Actions. This |
| | | way, groups of changes can be implemented without |
| | | flicker, followed by one call to DrawTree. |
| | | EnableNode = 9 --Make ChildNode enabled |
| | | DisableNode = 10 --Make ChildNode disabled |
| | | UpdateEnable = 11 --Make ChildNode enabled and |
| | | force it to repaint (does NOT repaint entire tree, just |
| | | the individual ChildNode) |
| | | UpdateDisable = 12 --Make ChildNode disabled and |
| | | force it to repaint (does NOT repaint entire tree, just |
| | | the individual ChildNode) |

SWTree Methods:

AdjustSize(iWidth As Integer, iHeight As Integer)

Allow run time code to resize tree. Under some environments (e.g. Microsoft® Internet Explorer 3.0) a change to Height or Width independently may reset the other. The preferred way to change both Height &Width is to call this method.

SWTree Events:

Click(KeyString as String)

This indicates that a User has clicked on a valid (i.e. Enabled) node of the Tree. The KeyString indicates the Unique string used when adding the particular node. There is no event to distinguish clicking on an item from clicking on a Plus/Minus image. In the document production platform usage of this control, this is not necessary since only those branches that are direct ancestors of the Selected Node are open at any time. Clicking a Plus sign will move to and Open that branch, but clicking a Minus will simply move to the first item below that Minus. A user cannot close the branch the user is in.

SWButton—The Graphical Buttons

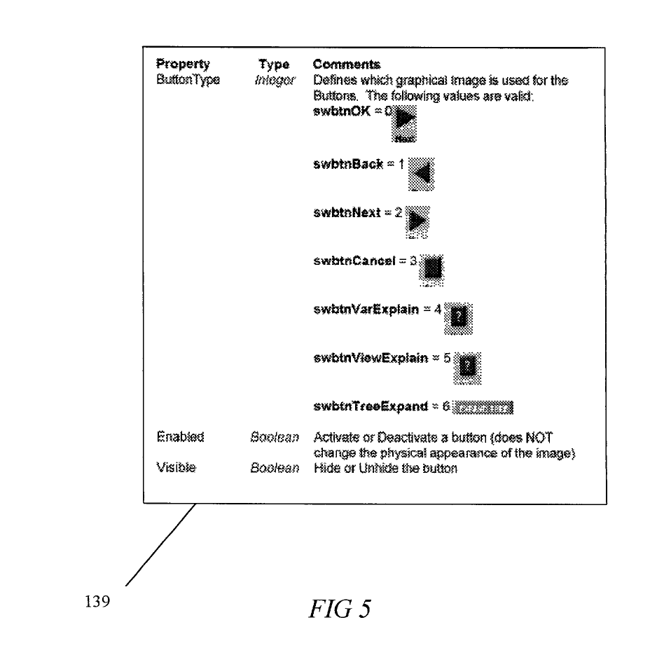

Referring to FIG. 5, list 139 shows the Button Controls used in HTML browser environments for use with the document production platform environment have the properties and associated events.

SWButton Events:

Click( )

Button has been clicked. Container should call ButtonAction(Click, ButtonID). The ButtonIDs referenced in ButtonAction are unrelated to the SWButton Control. which has no knowledge of the ButtonIDs used by the ViewManager. The container code is responsible for calling the ButtonAction method accurately.

GotFocus Button has-received Focus. Container should call ButtonAction(GotFocus, ButtonID).

OnMouseOver( )

Mouse has moved over the Button. This event is raised. but the Container is not responsible for implementing it.

Other Controls

The following controls reside on TheForm (SWVMForm. OCX)

SWVMMask.

OCX—Masked character Input. This control allows specification of a Mask property to force data entry validation.

Valid Mask characters are:

‘?’ Any letter (A-Z or a-z)

‘9’ Any Digit (0-9)

‘&’ Any Character is allowed in this position

All other chars in the Mask are considered part of the String. For example, the Mask for a Phone number might be “(999)999-9999”, where the parentheses, dash and spaces are FORCED into those positions.

SWVMReal. OCX—Real number editing. Properties include

TextLength Overall places in the number

DecimalPlaces Number of places right of the Decimal point

MoneyFormat True to prepend currency symbol to number

Separator True includes separator for 1000 groups.

SWVMDate. OCX—Date editing. Allows Separator property.

SWVMTime. OCX—Time editing. Properties include MilitaryTime, Separator, and ShowSeconds (all boolean).

SWTab—Graphical Tabstrip control.

SWTable—Database Table view control

Client-Server Data—Manager

The DataManager has component modules residing on both the Client and the Server. The document production platform controls under a container interface on the Client side. To that extent, the detailed workings of the server component of DataManager are not of concern to a user at the client side.

The client side of the DataManager (DataManClient) is a small footprint ATL DLL that makes use of DCOM technology to talk to its much larger Server Components. DataManClient requests information from a the document production platform application relevant to the Transaction &Document being processed for a Q&A. DataManClient intelligently manages that information to minimize all calls across the DCOM line, and both sides of DataManager make extensive use of default information and data compression to minimize the actual amount of Data crossing the DCOM line.

In order to use a document production platform application connecting through DataManClient, a system must have DCOM installed. Due to a problem in DCOM that prevents DCOM security parameters from being specified for individual Object connections, it is preferred that the following Registry entries be added HKEY_LOCAL_MACHINE\\Software\Microsoft\OLE\LegacyAuthenticationLevel=1 HKEY_LOCAL_MACHINE\\Software\Microsoft\OLE\LegacyImpersonationLevel=3

If DCOM is installed and these entries are not set, the ViewManager will attempt to set them when it installs. If these entries are set to different values, ViewManager will NOT reset them, but the document production platform Applications may not function correctly.

dmInterface SWDM_D is C++Class driven. The Main Class of SWDM_D is dmIntetface.

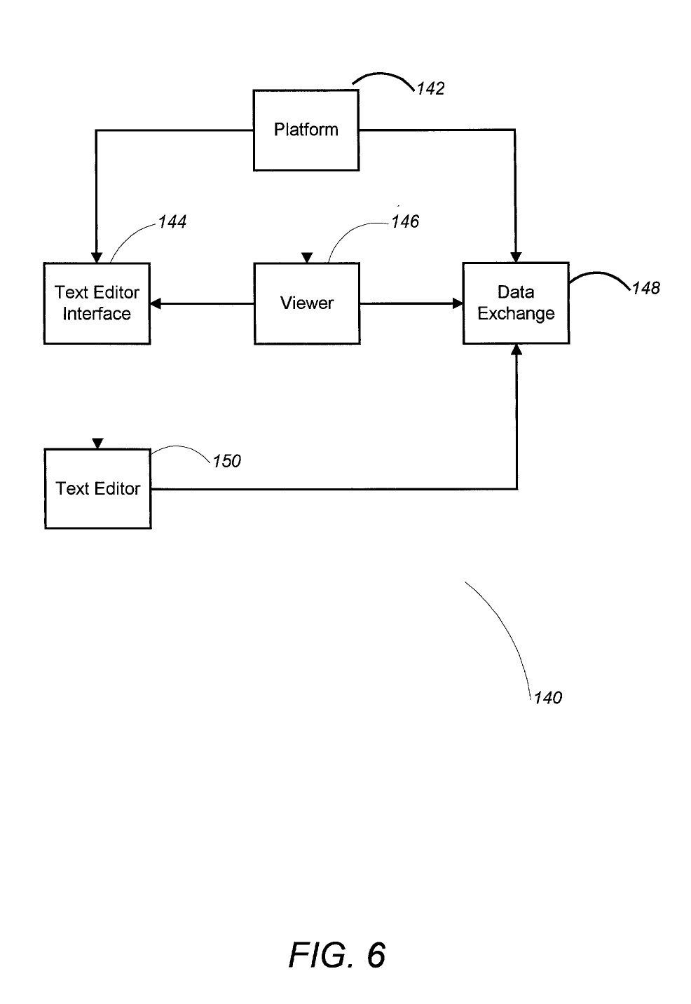

Referring to FIG. 6, a data flow diagram 140 of the document production platform is shown. From the platform 142, data may flow to the text editor interface 144 and thence to the text editor 150, with output to the data exchange 148. Similarly, data maf flow from the platform 142 to the viewer 146, and from there either to the text editor interface 144 in the case of textual data, or other data may flow directly to the data exchange 148.

API. The following dmInterface class members are used to interface with the data manager.

DmInterface

Constructor. One parameter is required. This parameter is a buffer that items can be passed in. Following is a list of possible items that may be passed in the constructor: ServerURL The server where the Server component of Dataman is located (SWDM_S).

ApplicationName The Application to be opened.

UserID (Optional) The User running the application. Used for Security and other properties of running this application.

Password (Optional)Password for the user.

RegisterView.

This method is a prerequisite to accessing data and displaying Dialog Boxes. The following are the parameters: Based On View Any previously opened view used to initialize the new view or on which the new view is based. This is especially important for viewing child data in one to many relationships.

View Number Identifier of the view, stored in the dictionary.

Switch Used for efficiency, determines the manner the view is opened. Options are:

rvDlALOG—General Purpose opening of a view.

rvVALUES_ONLY—server returns to the client only the values of the data objects and not the objects properties.

rvOPEN_ONLY—used only on the client side for miscellaneous processing.

Buffer Used to pass into the new view any starting values for that view, such as a Transaction Number or Client Number.

CommitChange

Commit to the appropriate database any values changed during the life of the view. Parameters: Data Handle: The handle of the view currently open from which the changes are to be committed.

Abort Changes

Abort update of any values changed during the life of the view. This will reset the values back to the original state. Parameters: Data Handle The handle of the view currently open from which the changes are to be committed.

SetCurrentValue

Set any variable to the current value:

Data Handle: The handle of the currently open view.

Identifier: Order number/identifier of a variable.

Value: The new value for the variable referred to by the identifier.

GetDataValue

Get the current value for a specified variable:

Data Handle: The handle of the currently open view.

Identifier: Order number/identifier of a variable.

Variable Name: Name of the variable to for which the value is to be retrieved.

Value: The retrieved value of the variable referred to by the identifier.

SetDataValue

Set the current value given:

Data Handle The handle of the currently open view.

Variable Name Name of the variable for which the value is to be set.

Value The new value of the specified variable.

ReadSeq

Load a list of dialogs to process as a Q&A.

DrivingView

View from a previous sequence.

Used for driving the new sequence.

FreeSeq Free up the sequence when finished running.

Handle The handle of the sequence.

Data Exchange

Data Exchange is the mechanism by which the data elements are communicated among the various components of the document production platform, such as documents, rules and data entry screens. The Data Exchange enables the user to enter data once and access that data when needed. Essential information regarding the nature of the data to be communicated by the data manager is defined in the Dictionary in a structure called a data view.

Several actions must be performed to facilitate communication of data to the viewer or a document.

Registering an application.

This starting point for the document production platform is the registering or opening of an application. When all processes are completed for the application, the application then needs to release the data handle allocated to it.

Registering a data handle.

Each process that requires data, uses a data handle with which to communicate. This data handle is initialized by passing an identifier (usually a number) of a view that provides the Data Manager with the information it needs to retrieve the data required for the particular event. After each individual process has been completed, that process then needs to release the handle from use.

Retrieving data.

This is done via the data handle. Using the data handle, one passes the item (Variable Name) of the data to be retrieved.

Updating the database.

Using the data handle, an item and its corresponding value are passed to the exchange for processing.

Viewer Communication.

The viewer is the set of controls and methods used to present data for update by the user. Different communication is necessary here. The viewer needs to know how to display the data and the means by which the user is allowed to modify the data. Each data view has the information the viewer needs for this purpose. Each object (Variable) of a view has specific properties communicated to the viewer via the exchange.

Evaluator/Formatter.

This module evaluates rules, calculations and phrases. It also formats data elements using format modifiers.

Evaluate Logic.

Evaluate a rule (true/false)

int-export pascal EvaluateLogict dmDATA_HANDLE Handle, char far *Text);

int-export Pascal EvaluateInstanceLogic(dmDATA_HANDLE Handle, char far *Text, long iInstance);

Evaluate Text.

Evaluate a block of text by replacing the variable name with the appropriate value

void-export Pascal EvaluateTextC dmDATA_HANDLE Handle, char far *Text);

void-export Pascal EvaluateInstanceTextC dmDATA_HANDLE Handle, char far *Text, long iInstance);

Format Data Value.

Apply the format modifiers in format string and apply them to the ValueBuffer. Format modifiers are separated by commas, and evaluated left to right.

void-export Pascal FormatDataValuet dmDATA_HANDLE iHandle, char

FormatString, char

ValueBuffer);

Data Cache

Stores the current values for efficient access. This also ensures the currency of values.

The following functions are used to interface with the data manager.

Register Application.

Register selected the document production platform application.

Application.

The name of the Application to open

UserId

The name of the user, used for retrieving their individual profile.

dmDATA_HANDLE

-export Pascal RegisterApplicationC char far

*Application, char far *UserId);

Un Register Application.

Terminate a currently opened application. Returns TRUE if Terminated, FALSE if unable to terminate. The switch decides if we check to see if it can unregister the application.

int-export Pascal UnRegisterApplication(dmDATA_HANDLE ApplicationHandle, int Switch);

Set IN/Path.

Set the path for the Application's INI file. This is also used to set the base path for the document production platform application.

### EXAMPLES

C:\sw\eplan\eplan.ini

C:\sw\eplan

void-export Pascal SetGcIniPathC char far *FullPath);

Setup Data Handle.

Setup Handle will take a View Number or the name of a section from an application INI file. It will take the Hand-IeName and if numeric will open a view, otherwise it will use that name as the section In the INI file

dmDATA HANDLE

-export Pascal SetupDataHandletchar far ‘HandleName);

dmDATA_HANDLE-export Pascal

SetupDataHandleFromHandle(dmDATA_HANDLE iHandle, char far *HandleName);

Setup View Handle.

‘Setup a View to be processed

dmDATA_HANDLE-export pascal SetupViewHandle(int ViewNumber);

dmDATA_HANDLE I,. port Pascal SetupViewHandleFromHandle(-_ATA_HANDLE iHandle, int View-Number);

Send Message.

‘Send a Message to the Data View Handler.

int-export Pascal dmSendMessage (dmDATA_HANDLE Handle, int MessageID, char far *MessageText, long *MessageNumber);

int-export Pascal dmSendReceiveMessage(dmDATA_HANDLE Handle, int MessageID, char far ‘MessageText, long *MessageNumber, char far **OutText);

Commit Changes.

Commit all changes.

int-export Pascal CommitChanges(dmDATA_HANDLE Handle);

Abort Changes.

‘Abort all changes.

void-export Pascal AbortChanges(dmDATA_HANDLE Handle);

Remove Data Handle.

Remove Data Handle will remove the instance of this handle from memory.

void-export Pascal RemoveDataHandlel dmDATA_HANDLE Handle);

Get Data Value. Get Data Value: Given a variable name and the data handle, It will return the value associated with that variable

char far *-export Pascal GetDataValue(dmDATA_HANDLE Handle, char far *VariableName, char far *ValueBuffer, char far *DataT; rpe);

Get Data Value.

Get Data Value: Given an order number and the data handle, It will return the value associated with that variable

int-export Pascal GetDataValue_Order(dmDATA_HANDLE Handle, int OrderNo, long iInstance, char far *ValueBuffer, int BufferSize);

Set Data Value.

Set Data Value: Based on the variable name *data handle. The Vale is set in the appropriate database(s). It will also Signal for the appropriate values to need to be recalculated if a value is invalid it will return the value of FALSE(0)

int-export Pascal SetDataValue (dmDATA_HANDLE Handle, char far *VariableName, char far *ValueBufferi;

int _export pa-_..-SetDataValue Order (dmDATA HANDLE Hal I int OrderNo, long iInstance, char far *ValueBuffer);

Undo Value.

UndoValue will set the value back to the original value

void-export Pascal UndoValue_Order(dmDATA_HANDLE Handle, int OrderNo, int Instance);

Get View Structure.

Return information necessary for processing a view struct ViewInformation*-export Pascal

GetViewStructure(dmDATA_HANDLE Handle);

First Variable Structure.

Return a structure of information for the first variable Associated with this handle.

struct VariableInformation*-export Pascal

FirstVariableStructure(dmDATA_HANDLE Handle);

Next Variable Structure.

Return information for the next variable for this handle struct VariableInformation 1-export Pascal

NextVariableStructure(dmDATA_HANDLE Handle);

Variable Structure.

Get information for a particular variable struct VariableInformation*-export Pascal VariableStructure(dmDATA_HANDLE Handle, int OrderNo);

struct VariableInformation 1-export Pascal VariableStructureByName(dmDATA_HANDLE Handle, char *iName);

Get Current Value.

Get current value in Structure. Return TRUE if changed???

int-export Pascal GetCurrentValue(dmDATA_HANDLE Handle, int OrderNo);

Set Current Value.

Return TRUE/FALSE if value is valid or not

int-export Pascal SetCurrentValuet dmDATA_HANDLE Handle, int OrderNo, char far *ValueBuf-fer);

Setup.

Input iDirectory: Directory where executable is located ie c:\sw

-void-export Pascal Setupichar *iDirectory);

Terminate.

Terminate Data Man

void_export Pascal Terminate( );

Iterations.

The number of times to loop.

Input:

CurrentViewHandle: DataHandle to use for this document

Buffer: string that is calculated to create the return value. For teams the buffer will have the Query Name or UOI name. Or the Variable by which they will be looping on. Output: The number of iterations this loop needs to run. unsigned long-export Pascal Iterationsf dmDATA_HANDLE CurrentViewHandle, char far *Buffer);

DataHandle.

Given the name of an Application, return the DataHandle. dmDATA_HANDLE _export Pascal ApplicationHandle(char far *ApplicationName, int Development)

Data Builder

Runs the appropriate driver, SQL query or data access necessary to retrieve the appropriate data.

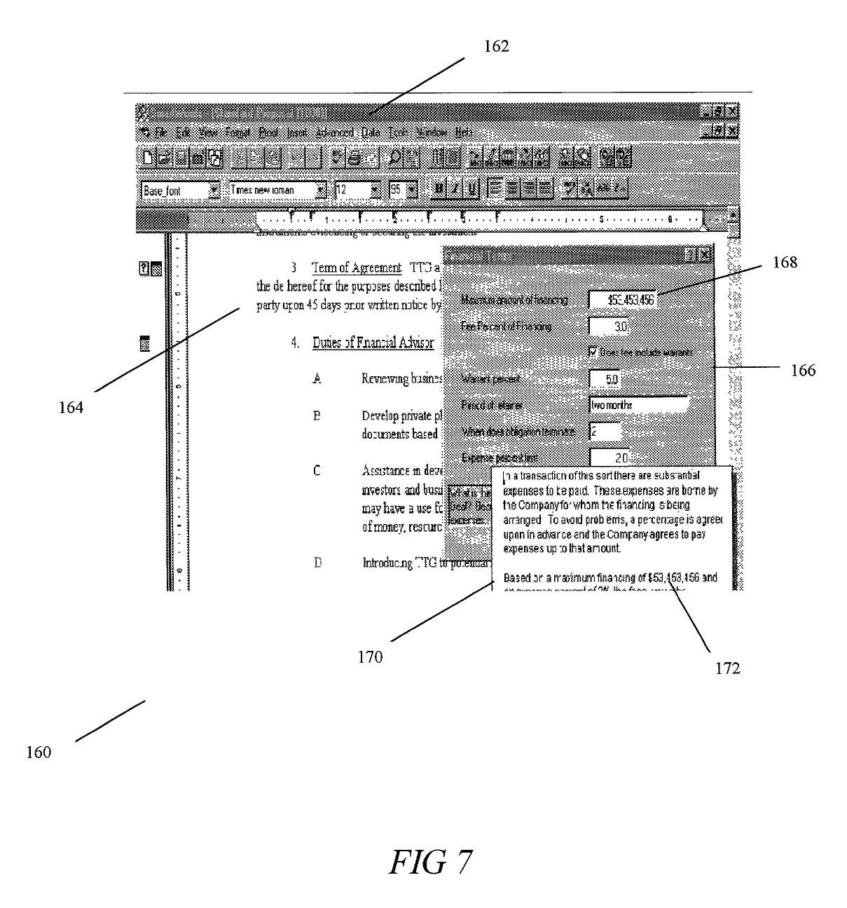

Referring to FIG. 7, an example screen 160 of a document being produced using an application developed under the document production platform is shown. In this example, the development application is a Windows® application, with the typical Windows® menu bar 162 across the top of the screen, modified to include specific menu items for the document production application. The document 164 is shown in the process of interactively gathering information from a user in the financial items popup window 166. This is an application specific window which allows a user to input the specific information for the application, such as the maximum amount of financing 168 in this example. An explanatory window 170 is shown having appeared to provide help with the input of information. The explanatory window changes depending upon the context and the information input; in this example, the amount of the maximum amount of financing 168 is shown in the window 170 as the basis 172 of a calculation. Other, more complex interactions are possible based upon rules, user input and context.

A number of embodiments of the invention have been described. Nevertheless, it will be understood that various modifications may be made without departing from the spirit and scope of the invention. For example, other operating systems such as Linux operating in graphical mode would be suitable. Accordingly, other embodiments are within the scope of the following claims.

What is claimed is:

1. A computer program product stored on a computer readable medium containing instructions to cause a computer to
automatically draft complex documents, analyses, forms, letters and other textual material;
provide material for the complex documents based on an interaction among information provided by a user; and
retrieve information stored in relational databases based on expert rules provided by one or more authors, and text fragments organized into one or more templates.

2. The computer program product of claim 1 wherein the instructions further comprise causing a computer to allow the user to manipulate the contents of the complex documents by changing one or more pieces of information.

3. The computer program product of claim 1 further comprising instructions causing a computer to apply a rule-based decision processing engine, which supports interactive question and answer sessions with a user to gather data, inform the user, and present the results of an analysis.

4. The computer program product of claim 1 wherein the data elicited is available for drafting of one or more documents.

5. The computer program product of claim 1 further comprising instructions causing a computer to access data from industry standard database engines and display and/or update that information, and where stores are defined in a dictionary, and are joined so information from multiple sources can be presented to a user or used in a knowledge application.

6. The computer program product of claim 4 further comprising instructions causing a computer to display explanatory material, the contents of which varies depending upon the contents of the data.

7. A method of automatically draft complex documents, analyses, forms, letters and other textual material comprising:
providing material for the complex documents based on an interaction among information provided by a user;
retrieving information stored in relational databases based on expert rules provided by one or more authors, and text fragments organized into one or more templates.

8. The method of claim 7 further comprising allowing the user to manipulate the contents of the complex documents by changing one or more pieces of information.

9. The method of claim 7 further comprising using a rule-based decision processing engine, supporting interactive question and answer sessions with a user to gather data, inform the user, and present the results of an analysis.

10. The method of claim 7 wherein the data elicited is available for drafting of one or more documents.

11. The method of claim 7 further comprising accessing data from industry standard database engines and display and/or update that information,
defining stores in a dictionary, and
joining such information from multiple sources can be presented to a user or used in a knowledge application.

12. The method of claim 10 further comprising displaying explanatory material, the contents of which varies depending upon the contents of the data.

13. A system for producing complex documents comprising
a computer, having a display, a keyboard, memory and mass storage;
instructions stored on a computer readable medium to cause a computer to automatically draft complex documents, analyses, forms, letters and other textual material;
provide material for the complex documents based on an interaction among information provided by a user; and
retrieve information stored in relational databases based on expert rules provided by one or more authors, and text fragments organized into one or more templates.
